(19) United States
(12) Patent Application Publication
(10) Pub. No.: US 2025/0390636 A1
(43) Pub. Date: Dec. 25, 2025

(54) METHOD FOR ACQUIRING LOCAL COORDINATES OF SPACE CURVE WELDS FOR STRUCTURAL STRESS CALCULATION

(71) Applicant: Dalian Jiaotong University, Dalian (CN)

(72) Inventor: Ji Fang, Dalian (CN)

(73) Assignee: Dalian Jiaotong University, Dalian, LN (CN)

(21) Appl. No.: 19/308,232

(22) Filed: Aug. 23, 2025

(30) Foreign Application Priority Data
Jul. 25, 2025 (CN) 202510977798.3

(51) Int. Cl. G06F 30/23

(52) U.S. Cl. CPC G06F 30/23

(57) ABSTRACT

A method for acquiring local coordinates of space curve welds for structural stress calculation is disclosed, and relates to the field of weld coordinate calculation technology, comprising: establishing a finite element model of a space weld; acquiring a tangent direction vector of a first node of the weld; acquiring a normal direction vector of a first node of the weld; acquiring a unit vector in a tangent direction of an intermediate node of the weld; acquiring a unit vector in a normal direction of an intermediate node of the weld; and acquiring a tangent direction vector and a normal direction vector of an end node of the weld. The present disclosure provides the method for acquiring local coordinates of space curve welds for structural stress calculation, which solves the problem that it is difficult to acquire local coordinates of complex space curve welds in prior art.

### TECHNICAL FIELD

The present disclosure relates to the field of weld coordinate calculation technology, particularly to a method for acquiring local coordinates of space curve welds for structural stress calculation.

### BACKGROUND

In the stress calculation of welded structures, the acquisition of local coordinates of welds is crucial, which directly affects the accuracy of structural stress calculation. Nevertheless, it remains challenging to acquire local coordinates for complex space curved welds, particularly for welds with changeable space twists and turns. When faced with such complex welds, the conventional method for acquiring local coordinates of welds typically has some problems, such as poor adaptability and unreliable acquisition direction, which can not meet the requirements of structural stress calculation. For example, by conventional methods it is difficult to reliably acquire the local coordinates of circular welds, tubular annular welds, and large and complex changeable space twists and turns welds. This is even more difficult in the case of shared nodes with triangular elements. Also, existing methods fail to deal adequately with complex welds of three-dimensional (3D) solid models. Consequently, there is an urgent requirement for a method that can reliably acquire the local coordinates of various complex space curve welds.

### SUMMARY

An objective of the present disclosure is to provide a method for acquiring local coordinates of space curve welds for structural stress calculation, to solve the problem that prior art methods have difficulties acquiring local coordinates of complex space curve welds.

In order to achieve the above objective, the present disclosure provides a method for acquiring local coordinates of a space curve weld for structural stress calculation, which includes the following steps:
Step 1, establishing a finite element model of a space weld;
Step 2, acquiring a tangent direction vector of a first node of the weld;
Step 3, acquiring a normal direction vector of a first node of the weld;
Step 4, acquiring a unit vector in a tangent direction of an intermediate node of the weld;
Step 5, acquiring a unit vector in a normal direction of an intermediate node of the weld; and
Step 6, acquiring a tangent direction vector and a normal direction vector of an end node of the weld.

In some embodiments, the specific process of step 1 is as follows:
S11, assuming there are i nodes in the finite element model of the space weld, and the nodes are represented by n, then each node is represented by nᵢ, iεN⁺, and the nodes include weld toe nodes and rear row nodes; from a starting of the weld, labeling the weld toe nodes located in a first row and the rear row nodes located in a second row in sequence, respectively;
S12, in the finite element model, connecting multiple adjacent nodes at the weld toe of a weld line perpendicular to one side of a plate thickness section to form an element, then there is j elements in the finite element model of the space weld, and each element is represented as eⱼ, j ε N⁺, and j elements form an element set, calling all the nodes on the weld toe of the weld line in the finite element model by the element set, and a same node may be called by different elements;
S13, assuming that the element set of the weld has 9 elements, and the element set calls a total of 15 nodes, where the 15 nodes are 7 weld toe nodes and 8 rear row nodes, respectively;
assuming that the elements e₁, e₂, e₅, and e₉ in the element set are quadrilaterals and the other elements are triangles;
wherein, e₁ consists of n₁, n₂, n₈, and n₉, e₂ consists of n₂, n₃, n₉, and n₁₀, e₃ consists of n₃, n₄, and n₁₀, e₄ consists of n₄, n₁₀ and n₁₁, e₅ consists of n₄, n₅, n₁₁, and n₁₂, e₆ consists of n₅, n₆, and n₁₂, e₇ consists of n₆, n₁₂, and n₁₃, e₈ consists of n₆, n₁₃, and n₁₄, and e₉ consists of n₆, n₇, n₁₄, and n₁₅.

In some embodiments, the specific process of step 2 is as follows:
S21, establishing a space rectangular coordinate system with each weld toe node as an origin; in the space rectangular coordinate system, regarding a plane where each element is located as an xny plane;
S22, a local tangent direction vector \vec{V}ₓ_{₁} of a first node n₁ of the weld is parallel to edges where n₁ and n₂ are located in the first element e₁, then \vec{V}ₓ_{₁} is the tangent direction vector of the starting of the weld, and the specific expression is as follows:

$${\vec{V}}_{{x}_{1}} = {\vec{V}}_{{n}_{2}} - {\vec{V}}_{{n}_{1}} ; \qquad ( 1 )$$

where \vec{V}ₙ_{₁} represents a vector of a global coordinate zero point pointing to n₁ in the finite element model; \vec{V}ₙ_{₂} represents a vector of a global coordinate zero point pointing to n₂ in the finite element model.

In some embodiments, the specific process of step 3 is as follows:
S31, acquiring \vec{V}_{z}_{₁} of the space rectangular coordinate system with n₁ as the origin by a cross-product operation of vectors of the edges where n₁ and n₂ are located and vectors of the edges where n₁ and n₈ are located, and the specific expression is as follows:

$${\vec{V}}_{{z}_{1}} = ( {\vec{V}}_{{n}_{2}} - {\vec{V}}_{{n}_{1}} ) \times ( {\vec{V}}_{{n}_{8}} - {\vec{V}}_{{n}_{1}} ) ; \qquad ( 2 )$$

where \vec{V}ₙ_{₈} represents a vector of a global coordinate zero point pointing to n₈ in the finite element model;
S32, performing the cross-product operation on the \vec{V}ₓ_{₁} and \vec{V}_{z}_{₁} to acquire the \vec{V}_{y}_{₁} coordinate axis direction vector \vec{V}_{y}_{₁} of the rectangular coordinate system with the n₁ as the origin; \vec{V}_{y}_{₁} is perpendicular to \vec{V}ₓ_{₁} and \vec{V}_{z}_{₁}, and is the normal direction vector at the node of the starting of the weld; the specific expression of \vec{V}_{y}_{₁} is as follows:

$${\vec{V}}_{{y}_{1}} = {\vec{V}}_{{x}_{1}} \times {\vec{V}}_{{z}_{1}} . \qquad ( 3 )$$

In some embodiments, the specific process of step 4 is as follows:
for the second node n₂:
S41, acquiring a virtual node m₁ by moving the unit displacement from node n₂ to a vector direction of n₂ pointing to n₁, then a vector of global coordinate zero point points to m₁ in the finite element model is \vec{V}ₘ_{₁}, the specific expression is as follows:

$${\vec{V}}_{{m}_{1}} = \frac{{\vec{V}}_{{n}_{1}} - {\vec{V}}_{{n}_{2}}}{\vert {\vec{V}}_{{n}_{1}} - {\vec{V}}_{{n}_{2}} \vert} + {\vec{V}}_{{n}_{2}} ; \qquad ( 4 )$$

S42, acquiring a virtual node m₂ by moving the unit displacement from node n₂ to a vector direction of n₂ pointing to n₃, then a vector of global coordinate zero point points to m₂ in the finite element model is \vec{V}ₘ_{₂}, the specific expression is as follows:

$${\vec{V}}_{{m}_{2}} = \frac{{\vec{V}}_{{n}_{3}} - {\vec{V}}_{{n}_{2}}}{\vert {\vec{V}}_{{n}_{3}} - {\vec{V}}_{{n}_{2}} \vert} + {\vec{V}}_{{n}_{2}} ; \qquad ( 5 )$$

where \vec{V}ₙ_{₃} represents a vector of the global coordinate zero point pointing to n₃ in the finite element model;
S43, through basic characteristics of an isosceles triangle, it is determined that \vec{V}ₘ_{₁}_{^{-m}}₂ is parallel to the tangent direction of n₂, acquiring a unit vector in the tangent direction \vec{V}ₓ_{₂} of n₂ through a vectorization formula, the specific expression is as follows:

$${\vec{V}}_{{x}_{2}} = \frac{{\vec{V}}_{{m}_{2}} - {\vec{V}}_{{m}_{1}}}{\vert {\vec{V}}_{{m}_{2}} - {\vec{V}}_{{m}_{1}} \vert} . \qquad ( 6 )$$

In some embodiments, the specific process of step 5 is as follows:
S51, unitizing a length of the vector \vec{V}ₙ_{₂}_{⁻ⁿ}₉ on a common edge of e₁ and e₂, and then performing the cross-product operation on the vector \vec{V}ₙ_{₂}_{⁻ⁿ}₉ with the unit vector \vec{V}ₘ_{₁} to acquire the unit vector in the normal direction \vec{V}_{z}_{₂₁} perpendicular to e₁, the specific expression is as follows:

$${\vec{V}}_{{z}_{21}} = {\vec{V}}_{{n}_{2} - {m}_{1}} \times \frac{{\vec{V}}_{{n}_{9}} - {\vec{V}}_{{n}_{2}}}{\vert {\vec{V}}_{{n}_{9}} - {\vec{V}}_{{n}_{2}} \vert} ; \qquad ( 7 )$$

where \vec{V}ₙ_{₉} represents a vector of the global coordinate zero point pointing to n₉ in the finite element model; \vec{V}ₙ_{₂}_{^{-m}}₁ is a unit vector of node n₂ pointing to m₁;
performing the cross-product operation to acquire an intermediate vector \vec{V}_{y}_{₂₁} at the node n₂ parallel to the element e₁ and perpendicular to the unit vector in the tangent direction \vec{V}ₓ_{₂} of the node n₂, the specific expression is as follows:

$${\vec{V}}_{{y}_{21}} = {\vec{V}}_{{x}_{2}} \times {\vec{V}}_{{z}_{21}} ; \qquad ( 8 )$$

S52, unitizing the length of the vector \vec{V}ₙ_{₂}_{⁻ⁿ}₉ on the common edge of e₁ and e₂, and then performing the cross-product operation on the vector \vec{V}ₙ_{₂}_{⁻ⁿ}₉ with the unit vector \vec{V}ₘ_{₂} to acquire the unit vector in the normal direction \vec{V}_{z}_{₂₂} perpendicular to e₁, the specific expression is as follows:

$${\vec{V}}_{{z}_{22}} = {\vec{V}}_{{n}_{2} - {m}_{2}} \times \frac{{\vec{V}}_{{n}_{9}} - {\vec{V}}_{{n}_{2}}}{\vert {\vec{V}}_{{n}_{9}} - {\vec{V}}_{{n}_{2}} \vert} ; \qquad ( 9 )$$

performing the cross-product operation to acquire an intermediate vector \vec{V}_{y}_{₂₂} at the node n₂ parallel to the element e₂ and perpendicular to the unit vector in the tangent direction \vec{V}ₓ_{₂} of the node n₂, the specific expression is as follows:

$${\vec{V}}_{{y}_{22}} = {\vec{V}}_{{x}_{2}} \times {\vec{V}}_{{z}_{22}} ; \qquad ( 10 )$$

S53, acquiring a unit vector in an angle bisector direction \vec{V}_{y}_{₂} of \vec{V}_{y}_{₂₁} and \vec{V}_{y}_{₂₂} of n₂ by adding the unit vectors, the specific expression is as follows:

$${\vec{V}}_{{y}_{2}} = \frac{{\vec{V}}_{{y}_{21}} + {\vec{V}}_{{y}_{22}}}{\vert {\vec{V}}_{{y}_{21}} + {\vec{V}}_{{y}_{22}} \vert} . \qquad ( 11 )$$

Through the above method, two different kinds of curved welds can be smoothly fused and their normal coordinates can be acquired, also, it can be applied to acquire the normal direction of the weld line of the space curve.

In some embodiments, the specific process of step 6 is as follows:
S61, a tangent direction vector \vec{V}ₓ_{₇} of n₇ is parallel to the edges where n₆ and n₇ are located in an isolator element e₉, then \vec{V}ₓ_{₇} is the tangent direction vector of n₇, and the specific expression is as follows:

$${\vec{V}}_{{x}_{7}} = {\vec{V}}_{{n}_{6}} - {\vec{V}}_{{n}_{7}} ; \qquad ( 21 )$$

where \vec{V}ₙ_{₆} represents a vector of the global coordinate zero point pointing to n₆ in the finite element model; \vec{V}ₙ_{₇} represents a vector of the global coordinate zero point pointing to n₇ in the finite element model;
S62, acquiring \vec{V}_{z}_{₇} of the space rectangular coordinate system with n₇ as the origin by the cross-product operation of vectors of the edges where n₆ and n₇ are located and vectors of the edges where n₇ and n₁₅ are located, and the specific expression is as follows:

$${\vec{V}}_{{z}_{7}} = ( {\vec{V}}_{{n}_{6}} - {\vec{V}}_{{n}_{7}} ) \times ( {\vec{V}}_{{n}_{15}} - {\vec{V}}_{{n}_{7}} ) ; \qquad ( 22 )$$

where \vec{V}ₙ_{₁₅} represents a vector of the global coordinate zero point pointing to n₁₅ in the finite element model;
S63, performing the cross-product operation on the \vec{V}ₓ_{₁} and \vec{V}_{z}_{₇} to acquire the V_{y}_{₇} coordinate axis direction vector \vec{V}_{y}_{₇} of the rectangular coordinate system with n₇ as the origin; that is, the specific expression of the normal direction vector \vec{V}_{y}_{₇} of n₇ is as follows:

$${\vec{V}}_{{y}_{7}} = {\vec{V}}_{{x}_{7}} \times {\vec{V}}_{{z}_{7}} . \qquad ( 23 )$$

In some embodiments, when equal to or more than two elements share the same node, the normal direction vector of the shared node is acquired;
among the assumed 15 nodes, n₄ and n₆ are shared by equal to or more than two units, and n₄ is taken as an example, n₄ is shared by e₃, e₄ and e₅, and the normal direction vector of n₄ is calculated;
S71, acquiring a virtual node m₄ by moving the unit displacement from node n₄ to a vector direction of n₄ pointing to n₃, then a vector of global coordinate zero point points to m₄ in the finite element model is \vec{V}ₘ_{₄}, the specific expression is as follows:

$${\vec{V}}_{{m}_{4}} = \frac{{\vec{V}}_{{n}_{3}} - {\vec{V}}_{{n}_{4}}}{\vert {\vec{V}}_{{n}_{3}} - {\vec{V}}_{{n}_{4}} \vert} + {\vec{V}}_{{n}_{4}} ; \qquad ( 12 )$$

where \vec{V}ₙ_{₄} represents a vector of the global coordinate zero point pointing to n₄ in the finite element model;
S72, acquiring a unit vector \vec{V}ₘ_{₅} of a direction of n₄ pointing to n₅, the specific expression is as follows:

$${\vec{V}}_{{m}_{5}} = \frac{{\vec{V}}_{{n}_{5}} - {\vec{V}}_{{n}_{4}}}{\vert {\vec{V}}_{{n}_{5}} - {\vec{V}}_{{n}_{4}} \vert} + {\vec{V}}_{{n}_{4}} ; \qquad ( 13 )$$

where \vec{V}ₙ_{₅} represents a vector of the global coordinate zero point pointing to n₅ in the finite element model;
S73, through the basic characteristics of the isosceles triangle, it is determined that \vec{V}ₘ_{₄}_{^{-m}}₅ is parallel to the tangent direction of n₄, acquiring a unit vector in the tangent direction \vec{V}ₓ_{₄} of n₄ through the vectorization formula, the specific expression is as follows:

$${\vec{V}}_{{x}_{4}} = \frac{{\vec{V}}_{{m}_{5}} - {\vec{V}}_{{m}_{4}}}{\vert {\vec{V}}_{{m}_{5}} - {\vec{V}}_{{m}_{4}} \vert} ; \qquad ( 14 )$$

S74, through the vector cross-product operation, acquiring the unit vectors \vec{V}_{z}_{₃}, \vec{V}_{z}_{₄} and \vec{V}_{z}_{₅} perpendicular to e₃, e₄ and e₅ respectively, the specific expressions are as follows:

$${\vec{V}}_{{z}_{3}} = \frac{{\vec{V}}_{{n}_{4} - {n}_{3}} \times {\vec{V}}_{{n}_{4} - {n}_{10}}}{\vert {\vec{V}}_{{n}_{4} - {n}_{3}} \times {\vec{V}}_{{n}_{4} - {n}_{10}} \vert} ; \qquad ( 15 )$$

$${\vec{V}}_{{z}_{4}} = \frac{{\vec{V}}_{{n}_{4} - {n}_{10}} \times {\vec{V}}_{{n}_{4} - {n}_{11}}}{\vert {\vec{V}}_{{n}_{4} - {n}_{10}} \times {\vec{V}}_{{n}_{4} - {n}_{11}} \vert} ; \qquad ( 16 )$$

$${\vec{V}}_{{z}_{3}} = \frac{{\vec{V}}_{{n}_{4} - {n}_{11}} \times {\vec{V}}_{{n}_{4} - {n}_{5}}}{\vert {\vec{V}}_{{n}_{4} - {n}_{11}} \times {\vec{V}}_{{n}_{4} - {n}_{5}} \vert} ; \qquad ( 17 )$$

where \vec{V}ₙ_{₄}_{⁻ⁿ}₃ represents the vector of n₄ pointing to n₃ in the finite element model; \vec{V}ₙ_{₄}_{⁻ⁿ}₁₀ represents the vector of n₄ pointing to n₁₀ in the finite element model; \vec{V}ₙ_{₄}_{⁻ⁿ}₁₁ represents the vector of n₄ pointing to n₁₁ in the finite element model; and \vec{V}ₙ_{₄}_{⁻ⁿ}₅ represents the vector of n₄ pointing to n₅ in the finite element model;
S75, acquiring temporary normal vectors \vec{V}_{y}_{₄₃}, \vec{V}_{y}_{₄₄} and \vec{V}_{y}_{₄₅} by performing the cross-product operation on the \vec{V}_{z}_{₃}, \vec{V}_{z}_{₄} and \vec{V}_{z}_{₅} with \vec{V}ₓ_{₄}, respectively, the specific expression is as follows:

$${\vec{V}}_{{y}_{43}} = \frac{{\vec{V}}_{{x}_{4}} \times {\vec{V}}_{{z}_{3}}}{\vert {\vec{V}}_{{x}_{4}} \times {\vec{V}}_{{z}_{3}} \vert} ; \qquad ( 18 )$$

$${\vec{V}}_{{y}_{44}} = \frac{{\vec{V}}_{{x}_{4}} \times {\vec{V}}_{{z}_{4}}}{\vert {\vec{V}}_{{x}_{4}} \times {\vec{V}}_{{z}_{4}} \vert} ; \qquad ( 19 )$$

$${\vec{V}}_{{y}_{45}} = \frac{{\vec{V}}_{{x}_{4}} \times {\vec{V}}_{{z}_{5}}}{\vert {\vec{V}}_{{x}_{4}} \times {\vec{V}}_{{z}_{5}} \vert} ; \qquad ( 20 )$$

S76, acquiring \vec{V}_{y}_{₃₄} by taking the angle bisector of \vec{V}_{y}_{₄₃} and \vec{V}_{y}_{₄₄}, and acquiring a final normal direction vector \vec{V}_{y}_{₄} by taking the angle bisector of \vec{V}_{y}_{₃₄} and \vec{V}_{y}_{₄₅}.

In some embodiments, n₆ is taken as an example, n₆ is shared by e₆, e₇, e₈ and e₉, and the normal direction vector of n₆ is calculated;
S81, firstly, acquiring temporary normal direction vectors \vec{V}_{y}_{₆₆}, \vec{V}_{y}_{₆₇}, \vec{V}_{y}_{₆₈} and \vec{V}_{y}_{₆₉} corresponding to e₆, e₇, e₈ and e₉ by repeating step 6;
S82, secondly, performing a bisector operation on the temporary normal direction vectors in pairs;
S83, finally, acquiring the final normal direction vector \vec{V}_{y}_{₆} by bisecting the scored temporary normal direction vectors in pairs again.

In some embodiments, when using an entity element modeling, firstly, a midplane virtual neutral layer is formed. Secondly, calculation is performed according to the method of steps 1 to 6. The specific process is as follows:
S91, acquiring partial midplane virtual nodes by taking an intermediate interpolation of the node coordinates in the thickness direction of the entity element;
S92, when connecting lines of nodes vertically corresponding to upper and lower surfaces of the elements are parallel to a surface of a plate, the nodes vertically corresponding to the upper and lower surfaces can be found, and acquiring the midplane virtual nodes and the corresponding midplane elements by averaging the upper and lower surfaces nodes; under the condition that the nodes vertically corresponding to the upper and lower surfaces of the elements cannot be found, acquiring the direction vector perpendicular to the thickness section of the entity element by using the vector cross-product operation, and acquiring other midplane virtual nodes by extending the unit length;
S93, all midplane virtual nodes form a virtual neutral 2D element layer; based on the virtual neutral 2D element layer, acquiring the local coordinates of the entity element space curve weld by adopting the methods of steps 2 to 6.

Therefore, the present disclosure adopts the method for acquiring local coordinates of space curve welds for structural stress calculation, and has the following beneficial effects:
(1) The tangential and normal local coordinates of the weld are acquired by vector operation, which can be applied to the local coordinate transformation of the weld and structural stress calculation.
(2) It can take into account the reliable acquisition of local coordinates of circular welds or tubular annular welds, so that the reliable acquisition of local coordinates of curved welds is achieved.
(3) The reliable acquisition of the local coordinates of large and complex changeable space twists and turns welds is achieved, which is the reliable acquisition of local coordinates of changeable space twists and turns welds by structural stress method.
(4) Through the transformation of the 2D element layer of the virtual node of the neutral layer, the reliable acquisition of the complex changeable space twists and turns welds of the 3D model is achieved.

Further detailed descriptions of the technical scheme of the present disclosure can be found in the accompanying drawings and embodiments.

### BRIEF DESCRIPTION OF THE DRAWINGS

FIG. 1 is an overall flow chart of a method for acquiring local coordinates of space curve welds for structural stress calculation according to the present disclosure;

FIG. 2 is a schematic structural diagram of a linear weld according to an embodiment of the present disclosure;

FIG. 3 is a schematic structural diagram of a circular weld according to an embodiment of the present disclosure;

FIG. 4 is a schematic structural diagram of an annular weld according to an embodiment of the present disclosure;

FIG. 5 is a schematic structural diagram of a space curve weld according to an embodiment of the present disclosure;

FIG. 6 is a schematic diagram of a space arbitrary curve weld according to an embodiment of the present disclosure;

FIG. 7 is a schematic diagram of acquiring local tangential and normal vectors of a first node according to an embodiment of the present disclosure;

FIG. 8 is a schematic diagram for acquiring a tangential vector of an intermediate node of a space arbitrary curve according to an embodiment of the present disclosure;

FIG. 9 is a schematic diagram for acquiring a normal vector of an intermediate node of a space arbitrary curve according to an embodiment of the present disclosure;

FIG. 10 is a schematic diagram of acquiring a normal vector of an end node of an arbitrary space curve according to an embodiment of the present disclosure;

FIG. 11 is a schematic diagram of acquiring tangential and normal vectors of intermediate nodes of space arbitrary curves according to an embodiment of the present disclosure;

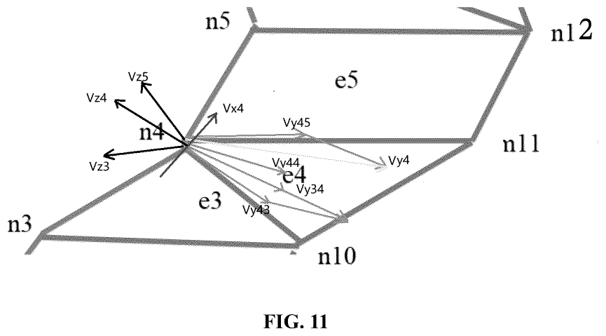

FIG. 12 is a schematic diagram of a virtual neutral layer transformation of an arbitrary space curve in a solid element according to an embodiment of the present disclosure.

### DETAILED DESCRIPTION OF THE EMBODIMENTS

The following detailed description of embodiments of the present disclosure provided in the accompanying drawings is not intended to limit the scope of the present disclosure as claimed, but is merely representative of selected embodiments of the present disclosure. All other embodiments obtained by those of ordinary skill in the art based on the embodiments of the present disclosure without involving any creative effort shall fall within the scope of protection of the present disclosure.

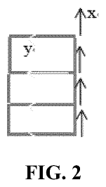

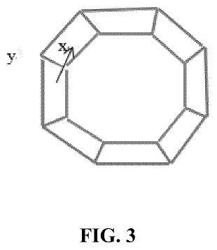

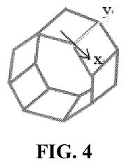

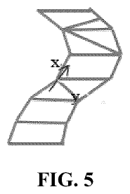

For linear weld line, circular weld line, or annular weld line, please refer to FIGS. 2-4, in which x and y represent the tangent direction and normal direction respectively; when the space tortuous weld line shown in FIG. 5 is acquired by combining the weld lines in FIG. 3 and FIG. 4, it is difficult to acquire the tangent direction and normal direction of the space tortuous weld line. Additionally, triangles interspersed in the quadrilateral in the finite element model will make it difficult to acquire the local coordinates of the weld line

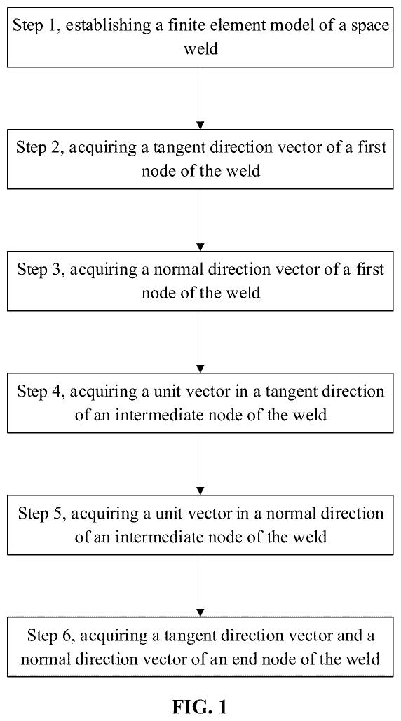

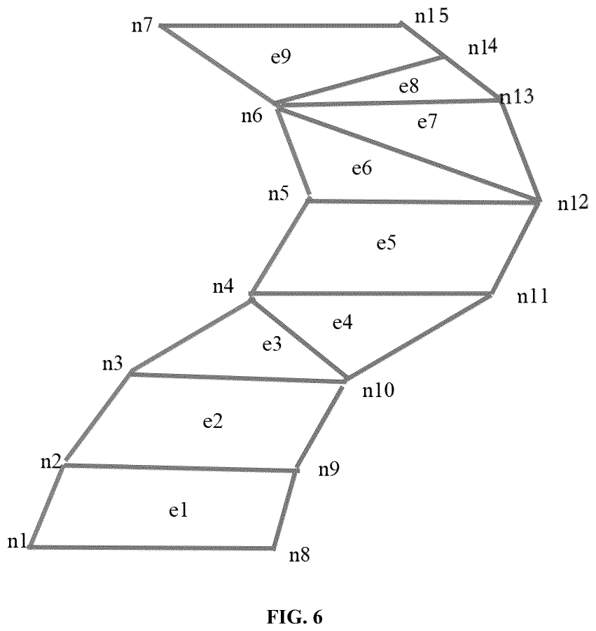

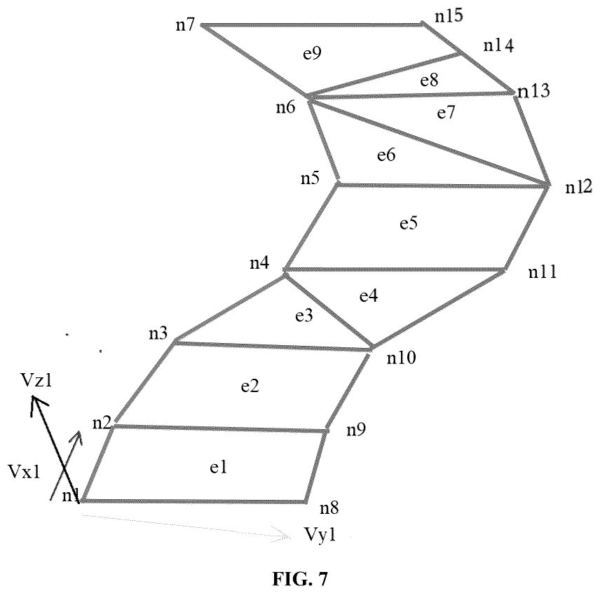

Accordingly, with reference to FIG. 1, a method for acquiring local coordinates of a space curve weld for structural stress calculation, which includes the following steps:
Step 1, the finite element model of the space weld is established;
S11, assumed there are i nodes in the finite element model of the space weld, and the nodes are represented by n, then each node is represented by nᵢ, iεN⁺, and the nodes include weld toe nodes and rear row nodes; from the starting of the weld, the weld toe nodes located in the first row and the rear row nodes located in the second row are labeled in sequence, respectively;
S12, in the finite element model, multiple adjacent nodes at the weld toe of the weld line perpendicular to one side of the plate thickness section are connected to form the element, then there is j elements in the finite element model of the space weld, and each element is represented as eⱼ, j ε N⁺, and j elements form the element set, calling all the nodes on the weld toe of the weld line in the finite element model by the element set, and the same node may be called by different elements;
S13, with reference to FIG. 6, assumed that the element set of the weld has 9 elements, and the element set calls the total of 15 nodes, where the 15 nodes are 7 weld toe nodes and 8 rear row nodes, respectively;
assumed that the elements e₁, e₂, e₅, and e₉ in the element set are quadrilaterals and the other elements are triangles;
wherein, e₁ consists of n₁, n₂, n₈, and n₉, e₂ consists of n₂, n₃, n₉, and n₁₀, e₃ consists of n₃, n₄, and n₁₀, e₄ consists of n₄, n₁₀ and n₁₁, e₅ consists of n₄, n₅, n₁₁, and n₁₂, e₆ consists of n₅, n₆, and n₁₂, e₇ consists of n₆, n₁₂, and n₁₃, e₈ consists of n₆, n₁₃, and n₁₄, and e₉ consists of n₆, n₇, n₁₄, and n₁₅.
Step 2, the tangent direction vector of the first node of the weld is acquired;
S21, the space rectangular coordinate system is established with each weld toe node as the origin; in the space rectangular coordinate system, the plane where each element is located is regarded as the xny plane;
S22, with reference to FIG. 7, the local tangent direction vector \vec{V}ₓ_{₁} of the first node n₁ of the weld is parallel to edges where n₁ and n₂ are located in the first element e₁, then \vec{V}ₓ_{₁} is the tangent direction vector of the starting of the weld, and the specific expression is as follows:

$${\vec{V}}_{{x}_{1}} = {\vec{V}}_{{n}_{2}} - {\vec{V}}_{{n}_{1}} ; \qquad ( 1 )$$

where \vec{V}ₙ_{₁} represents the vector of the global coordinate zero point of the finite element model pointing to n₁; \vec{V}ₙ_{₂} represents the vector of the global coordinate zero point of the finite element model pointing to n₂.
Step 3, the normal direction vector of the first node of the weld is acquired;
S31, \vec{V}_{z}_{₁} of the space rectangular coordinate system with n₁ as the origin is acquired by the cross-product operation of vectors of the edges where n₁ and n₂ are located and vectors of the edges where n₁ and n₈ are located, and the specific expression is as follows:

$${\vec{V}}_{{z}_{1}} = ( {\vec{V}}_{{n}_{2}} - {\vec{V}}_{{n}_{1}} ) \times ( {\vec{V}}_{{n}_{8}} - {\vec{V}}_{{n}_{1}} ) ; \qquad ( 2 )$$

where \vec{V}ₙ_{₈} represents the vector of the global coordinate zero point of the finite element model pointing to n₈;
S32, the cross-product operation is performed on the \vec{V}ₓ_{₁} and \vec{V}_{z}_{₁} to acquire the V_{y}_{₁} coordinate axis direction vector \vec{V}_{y}_{₁} of the rectangular coordinate system with the n₁ as the origin; \vec{V}_{y}_{₁} is perpendicular to \vec{V}ₓ_{₁} and \vec{V}_{z}_{₁}, and is the normal direction vector at the node of the starting of the weld; the specific expression of \vec{V}_{y}_{₁} is as follows:

$${\vec{V}}_{{y}_{1}} = {\vec{V}}_{{x}_{1}} \times {\vec{V}}_{{z}_{1}} . \qquad ( 3 )$$

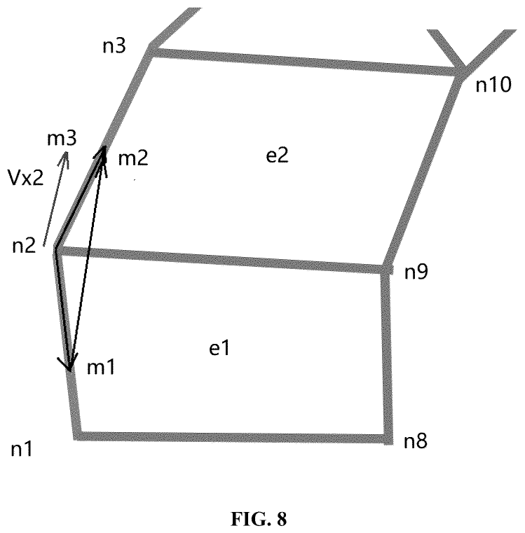

Step 4, the unit vector in the tangent direction of the intermediate node of the weld is acquired;
with reference to FIG. 8, for the second node n₂:
S41, the virtual node m₁ is acquired by moving the unit displacement from node n₂ to the vector direction of n₂ pointing to n₁, then the vector of global coordinate zero point points to m₁ in the finite element model is \vec{V}ₘ_{₁}, the specific expression is as follows:

$${\vec{V}}_{{m}_{1}} = \frac{{\vec{V}}_{{n}_{1}} - {\vec{V}}_{{n}_{2}}}{\vert {\vec{V}}_{{n}_{1}} - {\vec{V}}_{{n}_{2}} \vert} + {\vec{V}}_{{n}_{2}} ; \qquad ( 4 )$$

S42, the virtual node m₂ is acquired by moving the unit displacement from node n₂ to the vector direction of n₂ pointing to n₃, then the vector of global coordinate zero point points to m₂ in the finite element model is \vec{V}ₘ_{₂}, the specific expression is as follows:

$${\vec{V}}_{{m}_{2}} = \frac{{\vec{V}}_{{n}_{3}} - {\vec{V}}_{{n}_{2}}}{\vert {\vec{V}}_{{n}_{3}} - {\vec{V}}_{{n}_{2}} \vert} + {\vec{V}}_{{n}_{2}} ; \qquad ( 5 )$$

where \vec{V}ₙ_{₃} represents the vector of the global coordinate zero point pointing to n₃ in the finite element model;
S43, through basic characteristics of the isosceles triangle, it is determined that \vec{V}ₘ_{₁}_{^{-m}}₂ is parallel to the tangent direction of n₂, and acquiring the unit vector in the tangent direction \vec{V}ₓ_{₂} of n₂ through the vectorization formula, the specific expression is as follows:

$${\vec{V}}_{{x}_{2}} = \frac{{\vec{V}}_{{m}_{2}} - {\vec{V}}_{{m}_{1}}}{\vert {\vec{V}}_{{m}_{2}} - {\vec{V}}_{{m}_{1}} \vert} . \qquad ( 6 )$$

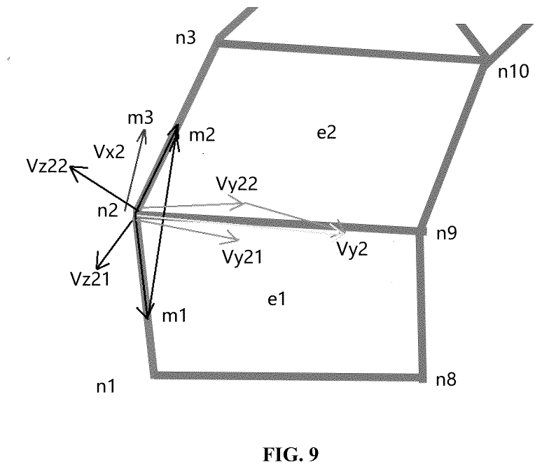

Step 5, the unit vector in the normal direction of the intermediate node of the weld is acquired, with reference to FIG. 9;
S51, the length of the vector \vec{V}ₙ_{₂}_{^{-m}}₉ on the common edge of e₁ and e₂ is unitized, and then the cross-product operation is performed on the vector \vec{V}ₙ_{₂}_{⁻ⁿ}₉ with the unit vector \vec{V}ₘ_{₁} to acquire the unit vector in the normal direction \vec{V}_{z}_{₂₁} perpendicular to e₁, the specific expression is as follows:

$${\vec{V}}_{{z}_{21}} = {\vec{V}}_{{n}_{2} - {m}_{1}} \times \frac{{\vec{V}}_{{n}_{9}} - {\vec{V}}_{{n}_{2}}}{\vert {\vec{V}}_{{n}_{9}} - {\vec{V}}_{{n}_{2}} \vert} ; \qquad ( 7 )$$

where \vec{V}ₙ_{₉} represents the vector of the global coordinate zero point pointing to n₉ in the finite element model; \vec{V}ₙ_{₂}_{^{-m}}₁ is the unit vector of node n₂ pointing to m₁;
the cross-product operation is performed to acquire the intermediate vector \vec{V}_{y}_{₂₁} at the node n₂ parallel to the element e₁ and perpendicular to the unit vector in the tangent direction \vec{V}ₓ_{₂} of the node n₂, the specific expression is as follows:

$${\vec{V}}_{{y}_{21}} = {\vec{V}}_{{x}_{2}} \times {\vec{V}}_{{z}_{21}} ; \qquad ( 8 )$$

S52, the length of the vector \vec{V}ₙ_{₂}_{⁻ⁿ}₉ on the common edge of e₁ and e₂ is unitized, and then the cross-product operation is performed on the vector \vec{V}ₙ_{₂}_{⁻ⁿ}₉ with the unit vector \vec{V}ₘ_{₂} to acquire the unit vector in the normal direction \vec{V}_{z}_{₂₂} perpendicular to e₁, the specific expression is as follows:

$${\vec{V}}_{{z}_{22}} = {\vec{V}}_{{n}_{2} - {m}_{2}} \times \frac{{\vec{V}}_{{n}_{9}} - {\vec{V}}_{{n}_{2}}}{\vert {\vec{V}}_{{n}_{9}} - {\vec{V}}_{{n}_{2}} \vert} ; \qquad ( 9 )$$

the cross-product operation is performed to acquire the intermediate vector \vec{V}_{y}_{₂₂} at the node n₂ parallel to the element e₂ and perpendicular to the unit vector in the tangent direction \vec{V}ₓ_{₂} of the node n₂, the specific expression is as follows:

$${\vec{V}}_{{y}_{22}} = {\vec{V}}_{{x}_{2}} \times {\vec{V}}_{{z}_{22}} ; \qquad ( 10 )$$

S53, the unit vector in the angle bisector direction \vec{V}_{y}_{₂} of \vec{V}_{y}_{₂₁} and \vec{V}_{y}_{₂₂} of n₂ is acquired by adding the unit vectors, the specific expression is as follows:

$${\vec{V}}_{{y}_{2}} = \frac{{\vec{V}}_{{y}_{21}} + {\vec{V}}_{{y}_{22}}}{\vert {\vec{V}}_{{y}_{21}} + {\vec{V}}_{{y}_{22}} \vert} . \qquad ( 11 )$$

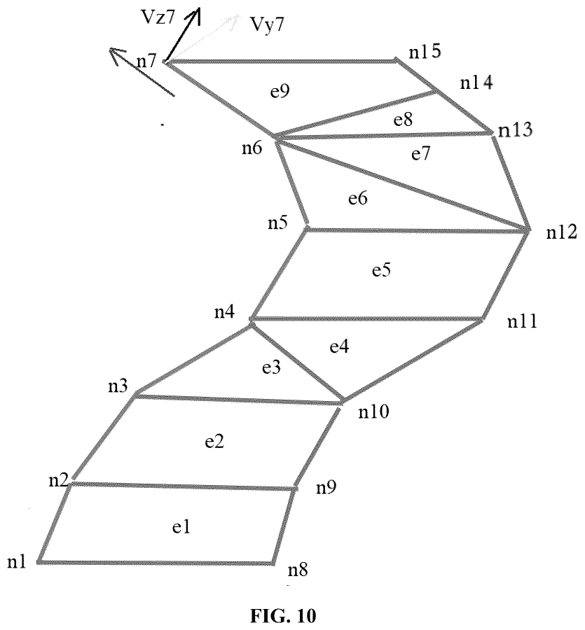

Through the above method, two different kinds of curved welds can be smoothly fused and their normal coordinates can be acquired, also, it can be applied to acquire the normal direction of the weld line of the space curve.
Step 6, the tangent direction vector and the normal direction vector of the end node of the weld are acquired, with reference to FIG. 10.
S61, the tangent direction vector \vec{V}ₓ_{₇} of n₇ is parallel to the edges where n₆ and n₇ are located in the isolator element e₉, then \vec{V}ₓ_{₇} is the tangent direction vector of n₇, and the specific expression is as follows:

$${\vec{V}}_{{x}_{7}} = {\vec{V}}_{{n}_{6}} - {\vec{V}}_{{n}_{7}} ; \qquad ( 21 )$$

where \vec{V}ₙ_{₆} represents the vector of the global coordinate zero point pointing to n₆ in the finite element model; \vec{V}ₙ_{₇} represents the vector of the global coordinate zero point pointing to n₇ in the finite element model;
S62, \vec{V}_{z}_{₇} of the space rectangular coordinate system with n₇ as the origin is acquired by the cross-product operation of vectors of the edges where n₆ and n₇ are located and vectors of the edges where n₇ and n₁₅ are located, and the specific expression is as follows:

$${\vec{V}}_{{z}_{7}} = ( {\vec{V}}_{{n}_{6}} - {\vec{V}}_{{n}_{7}} ) \times ( {\vec{V}}_{{n}_{15}} - {\vec{V}}_{{n}_{7}} ) ; \qquad ( 22 )$$

where \vec{V}ₙ_{₁₅} represents the vector of the global coordinate zero point pointing to n₁₅ in the finite element model;
S63, the cross-product operation is performed on the \vec{V}ₓ_{₇} and \vec{V}_{z}_{₇} to acquire the V_{y}_{₇} coordinate axis direction vector \vec{V}_{y}_{₇} of the rectangular coordinate system with n₇ as the origin; that is, the specific expression of the normal direction vector \vec{V}_{y}_{₇} of n₇ is as follows:

$${\vec{V}}_{{y}_{7}} = {\vec{V}}_{{x}_{7}} \times {\vec{V}}_{{z}_{7}} . \qquad ( 23 )$$

When equal to or more than two elements share the same node, the normal direction vector of the shared node is acquired;
among the assumed 15 nodes, n₄ and n₆ are shared by equal to or more than two units, and n₄ is taken as the example, n₄ is shared by e₃, e₄ and e₅, and the normal direction vector of n₄ is calculated.
S71, the virtual node m₄ is acquired by moving the unit displacement from node n₄ to the vector direction of n₄ pointing to n₃, then the vector of global coordinate zero point points to m₄ in the finite element model is \vec{V}ₘ_{₄}, the specific expression is as follows:

$${\vec{V}}_{{m}_{4}} = \frac{{\vec{V}}_{{n}_{3}} - {\vec{V}}_{{n}_{4}}}{\vert {\vec{V}}_{{n}_{3}} - {\vec{V}}_{{n}_{4}} \vert} + {\vec{V}}_{{n}_{4}} ; \qquad ( 12 )$$

where \vec{V}ₙ_{₄} represents the vector of the global coordinate zero point pointing to n₄ in the finite element model;
S72, the unit vector \vec{V}ₘ_{₅} of a direction of n₄ pointing to n₅ is acquired, the specific expression is as follows:

$${\vec{V}}_{{m}_{5}} = \frac{{\vec{V}}_{{n}_{5}} - {\vec{V}}_{{n}_{4}}}{\vert {\vec{V}}_{{n}_{5}} - {\vec{V}}_{{n}_{4}} \vert} + {\vec{V}}_{{n}_{4}} ; \qquad ( 13 )$$

where \vec{V}ₙ_{₅} represents the vector of the global coordinate zero point pointing to n₅ in the finite element model;
S73, through the basic characteristics of the isosceles triangle, it is determined that \vec{V}ₘ_{₄}_{^{-m}}₅ is parallel to the tangent direction of n₄, and the unit vector in the tangent direction \vec{V}ₓ_{₄} of n₄ is acquired through the vectorization formula, the specific expression is as follows:

$${\vec{V}}_{{x}_{4}} = \frac{{\vec{V}}_{{m}_{5}} - {\vec{V}}_{{m}_{4}}}{\vert {\vec{V}}_{{m}_{5}} - {\vec{V}}_{{m}_{4}} \vert} ; \qquad ( 14 )$$

S74, through the vector cross-product operation, the unit vectors \vec{V}_{z}_{₃}, \vec{V}_{z}_{₄} and \vec{V}_{z}_{₅} perpendicular to e₃, e₄ and e₅ are acquired respectively, the specific expressions are as follows:

$${\vec{V}}_{{z}_{3}} = \frac{{\vec{V}}_{{n}_{4} - {n}_{3}} \times {\vec{V}}_{{n}_{4} - {n}_{10}}}{\vert {\vec{V}}_{{n}_{4} - {n}_{3}} \times {\vec{V}}_{{n}_{4} - {n}_{10}} \vert} ; \qquad ( 15 )$$

$${\vec{V}}_{{z}_{4}} = \frac{{\vec{V}}_{{n}_{4} - {n}_{10}} \times {\vec{V}}_{{n}_{4} - {n}_{11}}}{\vert {\vec{V}}_{{n}_{4} - {n}_{10}} \times {\vec{V}}_{{n}_{4} - {n}_{11}} \vert} ; \qquad ( 16 )$$

$${\vec{V}}_{{z}_{5}} = \frac{{\vec{V}}_{{n}_{4} - {n}_{11}} \times {\vec{V}}_{{n}_{4} - {n}_{5}}}{\vert {\vec{V}}_{{n}_{4} - {n}_{11}} \times {\vec{V}}_{{n}_{4} - {n}_{5}} \vert} ; \qquad ( 17 )$$

where \vec{V}ₙ_{₄}_{⁻ⁿ}₃ represents the vector of n₄ pointing to n₃ in the finite element model; \vec{V}ₙ_{₄}_{⁻ⁿ}₁₀ represents the vector of n₄ pointing to n₁₀ in the finite element model; \vec{V}ₙ_{₄}_{⁻ⁿ}₁₁ represents the vector of n₄ pointing to n₁₁ in the finite element model; \vec{V}ₙ_{₄}_{⁻ⁿ}₅ represents the vector of n₄ pointing to n₅ in the finite element model;
S75, temporary normal vectors \vec{V}_{y}_{₄₃}, \vec{V}_{y}_{₄₄} and \vec{V}_{y}_{₄₅} are acquired by performing the cross-product operation on the \vec{V}_{z}_{₃}, \vec{V}_{z}_{₄} and \vec{V}_{z}_{₅} with \vec{V}ₓ_{₄} respectively the specific expression is as follows:

$${\vec{V}}_{{y}_{43}} = \frac{{\vec{V}}_{{x}_{4}} \times {\vec{V}}_{{z}_{3}}}{\vert {\vec{V}}_{{x}_{4}} \times {\vec{V}}_{{z}_{3}} \vert} ; \qquad ( 18 )$$

$${\vec{V}}_{{y}_{44}} = \frac{{\vec{V}}_{{x}_{4}} \times {\vec{V}}_{{z}_{4}}}{\vert {\vec{V}}_{{x}_{4}} \times {\vec{V}}_{{z}_{4}} \vert} ; \qquad ( 19 )$$

$${\vec{V}}_{{y}_{45}} = \frac{{\vec{V}}_{{x}_{4}} \times {\vec{V}}_{{z}_{5}}}{\vert {\vec{V}}_{{x}_{4}} \times {\vec{V}}_{{z}_{5}} \vert} ; \qquad ( 20 )$$

S76, \vec{V}_{y}_{₃₄} is acquired by taking the angle bisector of \vec{V}_{y}_{₄₃} and \vec{V}_{y}_{₄₄}, and the final normal direction vector \vec{V}_{y}_{₄} is acquired by taking the angle bisector of \vec{V}_{y}_{₃₄} and \vec{V}_{y}_{₄₅}.
n₆ is taken as the example, n₆ is shared by e₆, e₇, e₈ and e₉, and the normal direction vector of n₆ is calculated;
S81, temporary normal direction vectors \vec{V}_{y}_{₆₆}, \vec{V}_{y}_{₆₇}, \vec{V}_{y}_{₆₈} and \vec{V}_{y}_{₆₉} corresponding to e₆, e₇, e₈ and e₉ are acquired by repeating step 6;
S82, secondly, the bisector operation is performed on the temporary normal direction vectors in pairs;
S83, finally, the final normal direction vector \vec{V}_{y}_{₆} is acquired by bisecting the scored temporary normal direction vectors in pairs again.

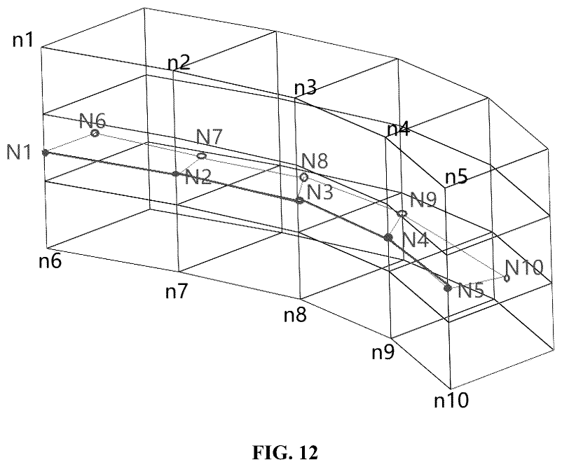

When using the entity element modeling, with reference to FIG. 12, firstly, the midplane virtual neutral layer is formed. Secondly, calculation is performed according to the method of steps 1 to 6. The specific process is as follows:
S91, the partial midplane virtual nodes is acquired by taking the intermediate interpolation of the node coordinates in the thickness direction of the entity element. Specifically, the midplane virtual node N1 is acquired by taking the intermediate interpolation of the coordinates of n1 and n6, and the midplane virtual node N2 is acquired by taking the intermediate interpolation of the coordinates of n2 and n7. Similarly, the midplane virtual nodes N3, N4, and N5 are acquired.
S92, when connecting lines of nodes vertically corresponding to upper and lower surfaces of the elements are parallel to the surface of the plate, the nodes vertically corresponding to the upper and lower surfaces can be found, and the midplane virtual nodes and the corresponding midplane elements are acquired by averaging the upper and lower surfaces nodes; under the condition that the nodes vertically corresponding to the upper and lower surfaces of the elements cannot be found, the direction vector perpendicular to the thickness section of the entity element is acquired by using the vector cross-product operation, and other midplane virtual nodes are acquired by extending the unit length. Specifically, cross-product operation is performed on the vector \vec{V}_{N1-n1} and \vec{V}_{N1-N2} and the unit length is taken to acquire the location coordinates of the virtual node N6. Similarly, the midplane virtual nodes N7, N8, N9, and N10 are acquired;
S93, all midplane virtual nodes from N1 to N10 form the virtual neutral 2D element layer; based on the virtual neutral 2D element layer, the tangent and normal direction coordinates of the weld line at each point N1-N5 on the weld toe section of the neutral layer along the weld line may be acquired by adopting the methods of steps 2 to 6, that is, the local coordinates of the space curve weld of the solid element.

Therefore, the present disclosure adopts the method for acquiring local coordinates of space curve welds for structural stress calculation, wherein the tangential and normal local coordinates of the weld are acquired by vector operation, which can be applied to the local coordinate transformation of the weld and structural stress calculation; it can take into account the reliable acquisition of local coordinates of circular welds or tubular annular welds, so that the reliable acquisition of local coordinates of curved welds is achieved; the reliable acquisition of the local coordinates of large and complex changeable space twists and turns welds are achieved, which is the reliable acquisition of local coordinates of changeable space twists and turns welds by structural stress method; and through the transformation of the 2D element layer of the virtual node of the neutral layer, the reliable acquisition of the complex changeable space twists and turns welds of the 3D model are achieved.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A method for acquiring local coordinates of a space curve weld for structural stress calculation, comprising the following steps:
Step 1, establishing a finite element model of a space weld;
Step 2, acquiring a tangent direction vector of a first node of the weld;
Step 3, acquiring a normal direction vector of a first node of the weld;
Step 4, acquiring a unit vector in a tangent direction of an intermediate node of the weld;
Step 5, acquiring a unit vector in a normal direction of an intermediate node of the weld; and
Step 6, acquiring a tangent direction vector and a normal direction vector of an end node of the weld.

2. The method for acquiring local coordinates of a space curve weld for structural stress calculation according to claim 1, wherein the process of step 1 comprises:
S11, given i nodes in the finite element model of the space weld, with nodes represented by n, and each node is represented by nᵢ, with iεN⁺, and wherein the nodes comprise weld toe nodes and rear row nodes; then from a starting of the weld, labeling the weld toe nodes located in a first row and the rear row nodes located in a second row in sequence, respectively;
S12, in the finite element model, connecting a plurality of adjacent nodes at the weld toe of a weld line perpendicular to one side of a plate thickness section to form an element, wherein each element is represented as eⱼ, with j ε N⁺, and wherein j elements form an element set, calling all the nodes on the weld toe of the weld line in the finite element model by the element set, wherein a same node may be called by different elements; and
S13, assuming that the element set of the weld has 9 elements, and the element set calls a total of 15 nodes, wherein the 15 nodes are 7 weld toe nodes and 8 rear row nodes, respectively;
assuming that the elements e₁, e₂, e₅, and e₉ in the element set are quadrilaterals and the other elements are triangles;
wherein e₁ consists of n₁, n₂, n₈, and n₉, e₂ consists of n₂, n₃, n₉, and n₁₀, e₃ consists of n₃, n₄, and n₁₀, e₄ consists of n₄, n₁₀ and n₁₁, e₅ consists of n₄, n₅, n₁₁, and n₁₂, e₆ consists of n₅, n₆, and n₁₂, e₇ consists of n₆, n₁₂, and n₁₃, e₈ consists of n₆, n₁₃, and n₁₄, and e₉ consists of n₆, n₇, n₁₄, and n₁₅.

3. The method for acquiring local coordinates of a space curve weld for structural stress calculation according to claim 2, wherein the process of step 2 comprises:
S21, establishing a space rectangular coordinate system with each weld toe node as an origin; in the space rectangular coordinate system, regarding a plane where each element is located as an xny plane; and
S22, establishing a local tangent direction vector \vec{V}ₓ_{₁} of a first node n₁ of the weld is parallel to edges where n₁ and n₂ are located in the first element e₁, then \vec{V}ₓ_{₁} is the tangent direction vector of the starting of the weld, and the specific expression comprises:
$${\vec{V}}_{{x}_{1}} = {\vec{V}}_{{n}_{2}} - {\vec{V}}_{{n}_{1}} ; \qquad ( 1 )$$
where \vec{V}ₙ_{₁} represents a vector of a global coordinate zero point pointing to n₁ in the finite element model; \vec{V}ₙ_{₂} represents a vector of a global coordinate zero point pointing to n₂ in the finite element model.

4. The method for acquiring local coordinates of a space curve weld for structural stress calculation according to claim 3, wherein the process of step 3 comprises:
S31, acquiring \vec{V}_{z}_{₁} of the space rectangular coordinate system with n₁ as the origin by a cross-product operation of vectors of the edges where n₁ and n₂ are located and vectors of the edges where n₁ and n₈ are located, and the specific expression comprises:
$${\vec{V}}_{{z}_{1}} = ( {\vec{V}}_{{n}_{2}} - {\vec{V}}_{{n}_{1}} ) \times ( {\vec{V}}_{{n}_{8}} - {\vec{V}}_{{n}_{1}} ) ; \qquad ( 2 )$$
where \vec{V}ₙ_{₈} represents a vector of a global coordinate zero point pointing to n₈ in the finite element model; and
S32, performing the cross-product operation on the \vec{V}ₓ_{₁} and \vec{V}_{z}_{₁} to acquire the V_{y}_{₁} coordinate axis direction vector \vec{V}_{y}_{₁} of the rectangular coordinate system with the n₁ as the origin; \vec{V}_{y}_{₁} is perpendicular to \vec{V}ₓ_{₁} and \vec{V}_{z}_{₁}, and is the normal direction vector at the node of the starting of the weld; the specific expression of \vec{V}_{y}_{₁} comprises:
$${\vec{V}}_{{y}_{1}} = {\vec{V}}_{{x}_{1}} \times {\vec{V}}_{{z}_{1}} . \qquad ( 3 )$$

5. The method for acquiring local coordinates of a space curve weld for structural stress calculation according to claim 4, wherein the process of step 4 comprises:
for the second node n₂:
S41, acquiring a virtual node m₁ by moving a unit displacement from node n₂ to a vector direction of n₂ pointing to n₁, then a vector of global coordinate zero point points to m₁ in the finite element model is \vec{V}ₘ_{₁}, the specific expression comprises:
$${\vec{V}}_{{m}_{1}} = \frac{{\vec{V}}_{{n}_{1}} - {\vec{V}}_{{n}_{2}}}{\vert {\vec{V}}_{{n}_{1}} - {\vec{V}}_{{n}_{2}} \vert} + {\vec{V}}_{{n}_{2}} ; \qquad ( 4 )$$
S42, acquiring a virtual node m₂ by moving the unit displacement from node n₂ to a vector direction of n₂ pointing to n₃, then a vector of global coordinate zero point points to m₂ in the finite element model is \vec{V}ₘ_{₂}, the specific expression comprises:
$${\vec{V}}_{{m}_{2}} = \frac{{\vec{V}}_{{n}_{3}} - {\vec{V}}_{{n}_{2}}}{\vert {\vec{V}}_{{n}_{3}} - {\vec{V}}_{{n}_{2}} \vert} + {\vec{V}}_{{n}_{2}} ; \qquad ( 5 )$$
where \vec{V}ₙ_{₃} represents a vector of the global coordinate zero point pointing to n₃ in the finite element model; and
S43, through basic characteristics of an isosceles triangle, it is determined that \vec{V}ₘ_{₁}_{^{-m}}₂ is parallel to the tangent direction of n₂, acquiring a unit vector in the tangent direction \vec{V}ₓ_{₂} of n₂ through a vectorization formula, the specific expression comprises:
$${\vec{V}}_{{x}_{2}} = \frac{{\vec{V}}_{{m}_{2}} - {\vec{V}}_{{m}_{1}}}{\vert {\vec{V}}_{{m}_{2}} - {\vec{V}}_{{m}_{1}} \vert} . \qquad ( 6 )$$

6. The method for acquiring local coordinates of a space curve weld for structural stress calculation according to claim 5, wherein the process of step 5 comprises:
S51, unitizing a length of the vector \vec{V}ₙ_{₂}_{⁻ⁿ}₉ on a common edge of e₁ and e₂, and then performing the cross-product operation on the vector \vec{V}ₙ_{₂}_{⁻ⁿ}₉ with the unit vector \vec{V}ₘ_{₁} to acquire the unit vector in the normal direction \vec{V}_{z}_{₂₁} perpendicular to e₁, the specific expression comprises:
$${\vec{V}}_{{z}_{21}} = {\vec{V}}_{{n}_{2} - {m}_{1}} \times \frac{{\vec{V}}_{{n}_{9}} - {\vec{V}}_{{n}_{2}}}{\vert {\vec{V}}_{{n}_{9}} - {\vec{V}}_{{n}_{2}} \vert} ; \qquad ( 7 )$$
where \vec{V}ₙ_{₉} represents a vector of the global coordinate zero point pointing to n₉ in the finite element model; \vec{V}ₙ_{₂}_{^{-m}}₁ is a unit vector of node n₂ pointing to m₁;
performing the cross-product operation to acquire an intermediate vector \vec{V}_{y}_{₂₁} at the node n₂ parallel to the element e₁ and perpendicular to the unit vector in the tangent direction \vec{V}ₓ_{₂} of the node n₂, the specific expression comprises:
$${\vec{V}}_{{y}_{21}} = {\vec{V}}_{{x}_{2}} \times {\vec{V}}_{{z}_{21}} ; \qquad ( 8 )$$
S52, unitizing the length of the vector \vec{V}ₙ_{₂}_{⁻ⁿ}₉ on the common edge of e₁ and e₂, and then performing the cross-product operation on the vector \vec{V}ₙ_{₂}_{⁻ⁿ}₉ with the unit vector \vec{V}ₘ_{₂} to acquire the unit vector in the normal direction \vec{V}_{z}_{₂₂} perpendicular to e₁, the specific expression comprises:
$${\vec{V}}_{{z}_{22}} = {\vec{V}}_{{n}_{2} - {m}_{2}} \times \frac{{\vec{V}}_{{n}_{9}} - {\vec{V}}_{{n}_{2}}}{\vert {\vec{V}}_{{n}_{9}} - {\vec{V}}_{{n}_{2}} \vert} ; \qquad ( 9 )$$
performing the cross-product operation to acquire an intermediate vector \vec{V}_{y}_{₂₂} at the node n₂ parallel to the element e₂ and perpendicular to the unit vector in the tangent direction \vec{V}ₓ_{₂} of the node n₂, the specific expression comprises:
$${\vec{V}}_{{y}_{22}} = {\vec{V}}_{{x}_{2}} \times {\vec{V}}_{{z}_{22}} ; \qquad ( 10 )$$
and
S53, acquiring a unit vector in an angle bisector direction \vec{V}_{y}_{₂} of \vec{V}_{y}_{₂₁} and \vec{V}_{y}_{₂₂} of n₂ by adding the unit vectors, the specific expression comprises:
$${\vec{V}}_{{y}_{2}} = \frac{{\vec{V}}_{{y}_{21}} - {\vec{V}}_{{y}_{22}}}{\vert {\vec{V}}_{{y}_{21}} - {\vec{V}}_{{y}_{22}} \vert} . \qquad ( 11 )$$

7. The method for acquiring local coordinates of a space curve weld for structural stress calculation according to claim 6, wherein the process of step 6 comprises:
S61, a tangent direction vector \vec{V}ₓ_{₇} of n₇ is parallel to the edges where n₆ and n₇ are located in an isolator element e₉, then \vec{V}ₓ_{₇} is the tangent direction vector of n₇, and the specific expression comprises:
$${\vec{V}}_{{x}_{7}} = {\vec{V}}_{{n}_{6}} - {\vec{V}}_{{n}_{7}} ; \qquad ( 21 )$$
where \vec{V}ₙ_{₆} represents a vector of the global coordinate zero point pointing to n₆ in the finite element model; \vec{V}ₙ_{₇} represents a vector of the global coordinate zero point pointing to n₇ in the finite element model;
S62, acquiring \vec{V}_{z}_{₇} of the space rectangular coordinate system with n₇ as the origin by the cross-product operation of vectors of the edges where n₆ and n₇ are located and vectors of the edges where n₇ and n₁₅ are located, and the specific expression comprises:
$${\vec{V}}_{{z}_{7}} = ( {\vec{V}}_{{n}_{6}} - {\vec{V}}_{{n}_{7}} ) \times ( {\vec{V}}_{{n}_{15}} - {\vec{V}}_{{n}_{7}} ) ; \qquad ( 22 )$$
where \vec{V}ₙ_{₁₅} represents a vector of the global coordinate zero point pointing to n₁₅ in the finite element model; and
S63, performing the cross-product operation on the \vec{V}ₓ_{₇} and \vec{V}_{z}_{₇} to acquire the \vec{V}_{y}_{₇} coordinate axis direction vector \vec{V}_{y}_{₇} of the rectangular coordinate system with n₇ as the origin; that is, the specific expression of the normal direction vector \vec{V}_{y}_{₇} of n₇ comprises:
$${\vec{V}}_{{y}_{7}} = {\vec{V}}_{{x}_{7}} \times {\vec{V}}_{{z}_{7}} . \qquad ( 23 )$$

8. The method for acquiring local coordinates of a space curve weld for structural stress calculation according to claim 7, wherein when equal to or more than two elements share one same node, the normal direction vector of the shared node is acquired;
among the assumed 15 nodes, n₄ and n₆ are shared by equal to or more than two units, and n₄ is taken as an example, n₄ is shared by e₃, e₄ and e₅, and the normal direction vector of n₄ is calculated;
S71, acquiring a virtual node m₄ by moving the unit displacement from node n₄ to a vector direction of n₄ pointing to n₃, then a vector of global coordinate zero point points to m₄ in the finite element model is \vec{V}ₘ_{₄}, the specific expression comprises:
$${\vec{V}}_{{m}_{4}} = \frac{{\vec{V}}_{{n}_{3}} - {\vec{V}}_{{n}_{4}}}{\vert {\vec{V}}_{{n}_{3}} - {\vec{V}}_{{n}_{4}} \vert} + {\vec{V}}_{{n}_{4}} ; \qquad ( 12 )$$
where \vec{V}ₙ_{₄} represents a vector of the global coordinate zero point pointing to n₄ in the finite element model;
S72, acquiring a unit vector \vec{V}ₘ_{₅} of a direction of n₄ pointing to n₅, the specific expression comprises:
$${\vec{V}}_{{m}_{5}} = \frac{{\vec{V}}_{{n}_{5}} - {\vec{V}}_{{n}_{4}}}{\vert {\vec{V}}_{{n}_{5}} - {\vec{V}}_{{n}_{4}} \vert} + {\vec{V}}_{{n}_{4}} ; \qquad ( 13 )$$
where \vec{V}ₙ_{₅} represents a vector of the global coordinate zero point pointing to n₅ in the finite element model;
S73, through the basic characteristics of the isosceles triangle, it is determined that \vec{V}ₘ_{₄}_{^{-m}}₅ is parallel to the tangent direction of n₄, acquiring a unit vector in the tangent direction \vec{V}ₓ_{₄} of n₄ through the vectorization formula, the specific expression comprises:
$${\vec{V}}_{{x}_{4}} = \frac{{\vec{V}}_{{m}_{3}} - {\vec{V}}_{{m}_{4}}}{\vert {\vec{V}}_{{m}_{5}} - {\vec{V}}_{{m}_{4}} \vert} ; \qquad ( 14 )$$
S74, through the vector cross-product operation, acquiring the unit vectors \vec{V}_{z}_{₃}, \vec{V}_{z}_{₄} and \vec{V}_{z}_{₅} perpendicular to e₃, e₄ and e₅ respectively, the specific expressions are as follows:
$${\vec{V}}_{{z}_{3}} = \frac{{\vec{V}}_{{n}_{4} - {n}_{3}} \times {\vec{V}}_{{n}_{4} - {n}_{10}}}{\vert {\vec{V}}_{{n}_{4} - {n}_{3}} \times {\vec{V}}_{{n}_{4} - {n}_{10}} \vert} ; \qquad ( 15 )$$
$${\vec{V}}_{{z}_{4}} = \frac{{\vec{V}}_{{n}_{4} - {n}_{10}} \times {\vec{V}}_{{n}_{4} - {n}_{11}}}{\vert {\vec{V}}_{{n}_{4} - {n}_{10}} \times {\vec{V}}_{{n}_{4} - {n}_{11}} \vert} ; \qquad ( 16 )$$
$${\vec{V}}_{{z}_{5}} = \frac{{\vec{V}}_{{n}_{4} - {n}_{11}} \times {\vec{V}}_{{n}_{4} - {n}_{5}}}{\vert {\vec{V}}_{{n}_{4} - {n}_{11}} \times {\vec{V}}_{{n}_{4} - {n}_{5}} \vert} ; \qquad ( 17 )$$
where \vec{V}ₙ_{₄}_{⁻ⁿ}₃ represents the vector of n₄ pointing to n₃ in the finite element model; \vec{V}ₙ_{₄}_{⁻ⁿ}₁₀ represents the vector of n₄ pointing to n₁₀ in the finite element model; \vec{V}ₙ_{₄}_{⁻ⁿ}₁₁ represents the vector of n₄ pointing to n₁₁ in the finite element model; and \vec{V}ₙ_{₄}_{⁻ⁿ}₅ represents the vector of n₄ pointing to n₅ in the finite element model;
S75, acquiring temporary normal vectors \vec{V}_{y}_{₄₃}, \vec{V}_{y}_{₄₄} and \vec{V}_{y}_{₄₅} by performing the cross-product operation on the \vec{V}_{z}_{₃}, \vec{V}_{z}_{₄} and \vec{V}_{z}_{₅} with \vec{V}ₓ_{₄} respectively the specific expression comprises:
$${\vec{V}}_{{y}_{43}} = \frac{{\vec{V}}_{{x}_{4}} \times {\vec{V}}_{{z}_{3}}}{\vert {\vec{V}}_{{x}_{4}} \times {\vec{V}}_{{z}_{3}} \vert} ; \qquad ( 18 )$$
$${\vec{V}}_{{y}_{44}} = \frac{{\vec{V}}_{{x}_{4}} \times {\vec{V}}_{{z}_{4}}}{\vert {\vec{V}}_{{x}_{4}} \times {\vec{V}}_{{z}_{4}} \vert} ; \qquad ( 19 )$$
$${\vec{V}}_{{y}_{45}} = \frac{{\vec{V}}_{{x}_{4}} \times {\vec{V}}_{{z}_{5}}}{\vert {\vec{V}}_{{x}_{4}} \times {\vec{V}}_{{z}_{5}} \vert} ; \qquad ( 20 )$$
and
S76, acquiring \vec{V}_{y}_{₃₄} by taking the angle bisector of \vec{V}_{y}_{₄₃} and \vec{V}_{y}_{₄₄}, and acquiring a final normal direction vector \vec{V}_{y}_{₄} of n₄ by taking the angle bisector of \vec{V}_{y}_{₃₄} and \vec{V}_{y}_{₄₅}.

9. The method for acquiring local coordinates of a space curve weld for structural stress calculation according to claim 8, wherein
n₆ is taken as an example, n₆ is shared by e₆, e₇, e₈ and e₉, and the normal direction vector of n₆ is calculated;
S81, firstly, acquiring temporary normal direction vectors \vec{V}_{y}_{₆₆}, \vec{V}_{y}_{₆₇}, \vec{V}_{y}_{₆₈} and \vec{V}_{y}_{₆₉} corresponding to e₆, e₇, e₈ and e₉ by repeating step 6;
S82, secondly, performing a bisector operation on the temporary normal direction vectors in pairs; and
S83, finally, acquiring the final normal direction vector \vec{V}_{y}_{₆} by bisecting the scored temporary normal direction vectors in pairs again.

10. The method for acquiring local coordinates of a space curve weld for structural stress calculation according to claim 9, wherein when using an entity element modeling, firstly, a midplane virtual neutral layer is formed, secondly, calculation is performed according to the method of steps 1 to 6; wherein the process comprises:
S91, acquiring partial midplane virtual nodes by taking an intermediate interpolation of the node coordinates in the thickness direction of the entity element;
S92, when connecting lines of nodes vertically corresponding to upper and lower surfaces of the elements are parallel to a surface of a plate, and acquiring the midplane virtual nodes and the corresponding midplane elements by averaging the upper and lower surfaces nodes; under the condition that the nodes vertically corresponding to the upper and lower surfaces of the elements cannot be found, acquiring the direction vector perpendicular to the thickness section of the entity element by using the vector cross-product operation, and acquiring other midplane virtual nodes by extending the unit length; and
S93, all midplane virtual nodes form a virtual neutral 2D element layer; based on the virtual neutral 2D element layer, acquiring the local coordinates of the entity element space curve weld by adopting the methods of steps 2 to 6.
